(19) United States
(12) Patent Application Publication
(10) Pub. No.: US 2026/0219824 A1
(43) Pub. Date: Jul. 30, 2026

(54) DISPLAY SYSTEM AND INFORMATION PROCESSING DEVICE

(71) Applicant: SEIKO EPSON CORPORATION, Tokyo (JP)

(72) Inventor: Issei YOKOYAMA, SAPPORO-SHI (JP)

(21) Appl. No.: 19/456,038

(22) Filed: Jan. 22, 2026

(30) Foreign Application Priority Data
Jan. 24, 2025 (JP) 2025-010394

(51) Int. Cl. G06F 3/14; H04N 5/74

(52) U.S. Cl. CPC G06F 3/14; H04N 5/74

(57) ABSTRACT

According to an aspect of the present disclosure, there is provided a display system including a projector and a terminal device including an imager, a display, and a second controller. The projector displays a code image in red and displays another code image in blue, the second controller displays, on the display, guidance information for guiding a user to capture the code image with the imager, and the guidance information includes information indicating that a color of the code image is red.

The present application is based on, and claims priority from JP Application Serial Number 2025-010394, filed Jan. 24, 2025, the disclosure of which is hereby incorporated by reference herein in its entirety.

### BACKGROUND

### 1. Technical Field

The present disclosure relates to a display system and an information processing device.

### 2. Related Art

JP-A-2020-182196 proposes an image forming apparatus that, when trouble has occurred in the apparatus, displays, on a display, a two-dimensional code for providing information indicating a method of coping with the trouble. A user can check the method of coping with the trouble by reading the displayed two-dimensional code with portable equipment or the like. In this image forming apparatus, when a plurality of troubles have occurred in the apparatus, a plurality of two-dimensional codes are displayed on the display.

JP-A-2020-182196 is an example of the related art.

However, when a plurality of two-dimensional codes are simultaneously or sequentially displayed on the display, the user sometimes reads a two-dimensional code different from a two-dimensional code that the user should originally read.

### SUMMARY

According to an aspect of the present disclosure, there is provided a display system including: an image display device; and an information processing device including a camera, a display, and a controller, wherein the image display device displays a first code image in a first color and displays a second code image in a second color different from the first color, the controller displays, on the display, first guidance information for guiding a user to capture the first code image with the camera, and the first guidance information includes information indicating that a color of the first code image is the first color.

According to an aspect of the present disclosure, there is provided an information processing device including a camera, a display, and a controller, wherein the controller displays, on the display, first guidance information for guiding a user to capture, among a first code image displayed in a first color by an image display device and a second code image displayed in a second color different from the first color by the image display device, the first code image with the camera, and the first guidance information includes information indicating that a color of the first code image is the first color.

### BRIEF DESCRIPTION OF THE DRAWINGS

FIG. 1 is a configuration diagram illustrating a schematic configuration of a display system.

FIG. 2 is a block diagram illustrating internal configurations of a projector and a terminal device.

FIG. 3 is a flowchart illustrating an operation of the display system at the time when the projector and the terminal device are connected by a wireless LAN.

FIG. 4 is a diagram illustrating a projection image projected by the projector.

FIG. 5 is a diagram illustrating a projection image projected by the projector.

FIG. 6 is a diagram illustrating a display image displayed on a display of the terminal device.

FIG. 7 is a diagram illustrating a display image displayed on the display of the terminal device.

FIG. 8 is a diagram illustrating a display image displayed on the display of the terminal device.

FIG. 9 is a diagram illustrating a projection image projected by a projector according to a modification.

FIG. 10 is a diagram illustrating a display image displayed on a display of a terminal device according to the modification.

### DESCRIPTION OF EMBODIMENTS

### 1. Embodiment

Hereinafter, a display system 100 in an embodiment is explained with reference to the drawings.

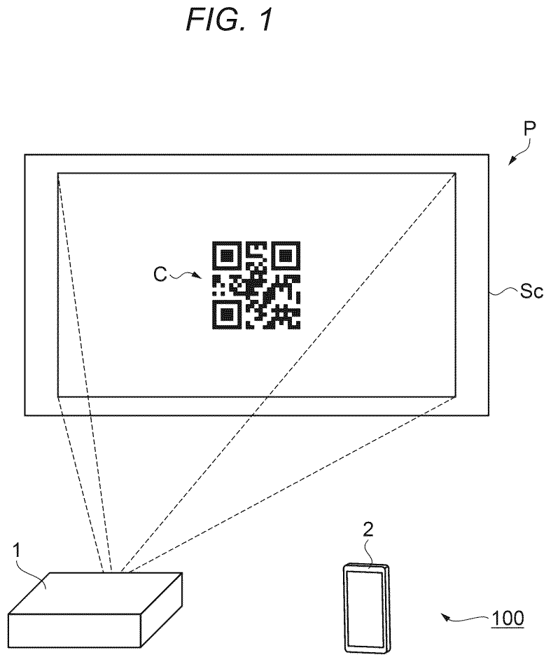

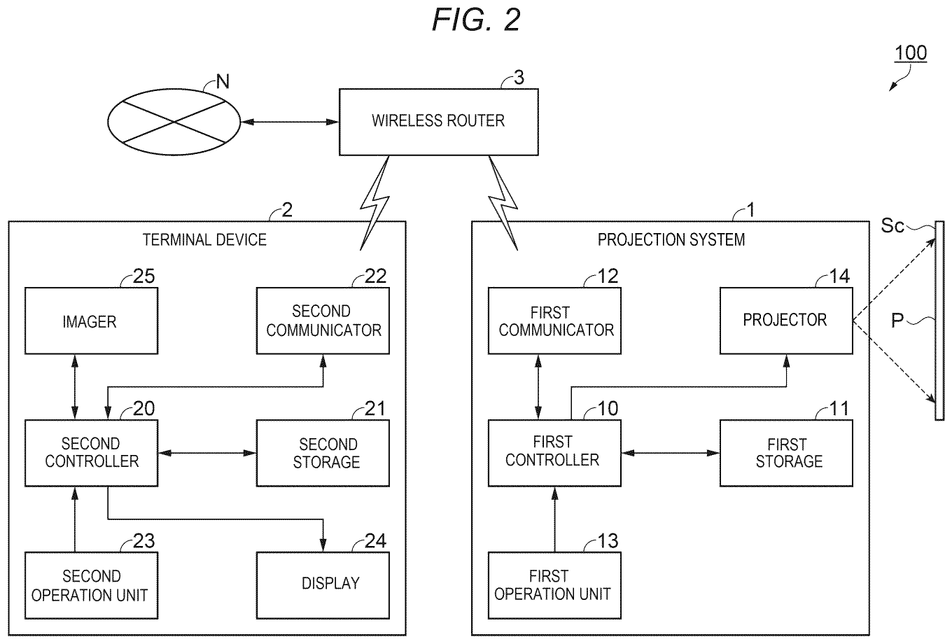

FIG. 1 is a configuration diagram illustrating a schematic configuration of the display system 100. FIG. 2 is a block diagram illustrating internal configurations of a projection system 1 and a terminal device 2.

As illustrated in FIGS. 1 and 2, the display system 100 includes the projection system 1 that projects image light onto a projection surface Sc and the terminal device 2 operated by a user of the projection system 1.

The projection system 1 includes a first controller 10, a first storage 11, a first communicator 12, a first operation unit 13, and a projector 14. The projection system 1 projects image light from the projector 14 to thereby display a projection image P on the projection surface Sc. The projection system 1 is an example of an image display device.

The first controller 10 includes one or a plurality of processors such as a central processing unit (CPU). The first controller 10 operates according to a control program stored in the first storage 11 to thereby control an operation of the projection system 1.

The first storage 11 includes memories such as a random access memory (RAM) and a read only memory (ROM). The RAM is used for temporary storage of various data and the like. The ROM stores a control program for controlling the operation of the projection system 1, control data, various image data, and the like.

The first communicator 12 is connected to a wireless router 3 by a wireless local area network (LAN) and is connected to a network N via the wireless router 3. The first communicator 12 includes an interface circuit for performing communication via the network N and can perform communication with other devices connected to the network N. Besides the projection system 1, the terminal device 2 is connected to the network N in the present embodiment. The first communicator 12 can input and output information to and from the terminal device 2 via the network N. The first communicator 12 may be connected to the network N by wire not via the wireless router 3.

The first operation unit 13 includes a plurality of operation keys (not illustrated) for the user to give various instructions to the projection system 1. When the user operates an operation key of the first operation unit 13, the first operation unit 13 outputs an operation signal corresponding to details of the operation by the user to the first controller 10. Note that a not-illustrated remote controller that can be remotely operated may be used as the first operation unit 13. In this case, the remote controller transmits an infrared operation signal corresponding to the details of the operation by the user and a not-illustrated remote controller signal receiver receives the operation signal and transmits the operation signal to the first controller 10.

The projector 14 projects image light based on image data supplied from a not-illustrated external image supply device or image data stored in the first storage 11 and displays the projection image P on the projection surface Sc. Although not illustrated, the projector 14 includes a light source device, a light modulation device that modulates light emitted by the light source device to form image light, and a projection lens that projects the image light.

The projection system 1 in the present embodiment is capable of projecting a code image C (see FIG. 1) from the projector 14. The code image C is, for example, a QR code (registered trademark) which is a matrix type two-dimensional code. The user can cause the terminal device 2 to execute a predetermined operation by reading the projected code image C with the terminal device 2.

The terminal device 2 is a portable information processing device used by the user of the projection system 1 and includes, for example, a smartphone or a tablet terminal device.

The terminal device 2 includes a second controller 20, a second storage 21, a second communicator 22, a second operation unit 23, a display 24, and an imager 25. The second controller 20 includes a processor such as a CPU and controls an operation of the terminal device 2 by operating according to a not-illustrated operating system (OS), application programs, or the like stored in the second storage 21. The second controller 20 is an example of a controller.

The second storage 21 includes a storage device such as a memory and stores the OS, the application programs, the various data, and the like explained above.

The second communicator 22 is connected to the wireless router 3 via a wireless LAN and is connected to the network N via the wireless router 3. The second communicator 22 includes an interface circuit for performing communication via the network N and can perform communication with other devices connected to the network N. The connection between the second communicator 22 and the network N is normally wireless connection but may be wired connection.

The second operation unit 23 receives input operation of the user. The second operation unit 23 outputs operation information corresponding to the received input operation to the second controller 20. The display 24 includes a display device such as a liquid crystal display or an organic electro luminescence (EL) display and displays various information based on control of the second controller 20. The second operation unit 23 may be configured integrally with the display 24 like a touch panel.

The imager 25 is a camera including a not-illustrated imaging element such as a CCD sensor or a CMOS sensor and a not-illustrated imaging lens. The imager 25 images an imaging range corresponding to the direction and the posture of the terminal device 2 and generates a captured image. The imager 25 outputs the generated captured image to the second controller 20.

Various application programs (not illustrated) are installed in the terminal device 2. The second controller 20 is capable of executing various operations according to started application programs. The application programs installed in the terminal device 2 include a reading program for reading the code image C captured by the imager 25 and a web browser for displaying a web page.

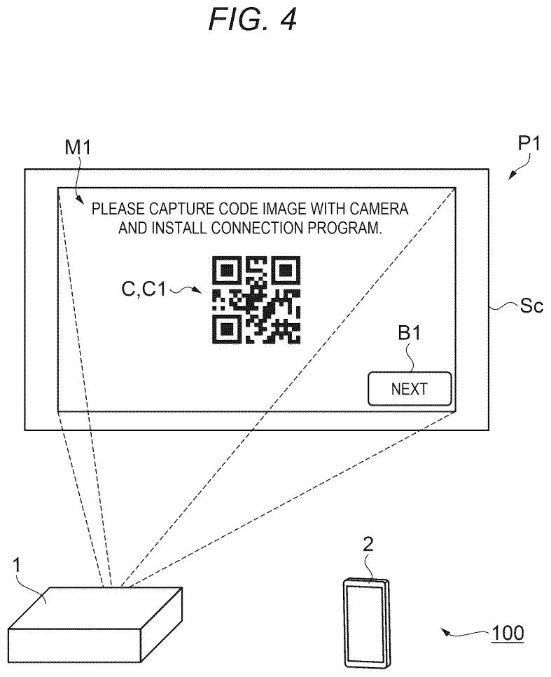

In the present embodiment, image data of a plurality of code images C are stored in the first storage 11 of the projection system 1. The projection system 1 can project various code images C. Specifically, image data of a code image C1 (see FIG. 4) for installing a connection program in the terminal device 2 is stored in the first storage 11. The connection program is an application program for connecting the terminal device 2 and the projection system 1 via the wireless LAN. The code image C1 represents a uniform resource locator (URL) that should be accessed when the connection program is installed. When the user captures the code image C1 projected from the projection system 1 with the imager 25 of the terminal device 2, the terminal device 2 accesses the URL and installs the connection program. The code image C1 is an example of a second code image. The URL represented by the code image C1 is an example of a second address.

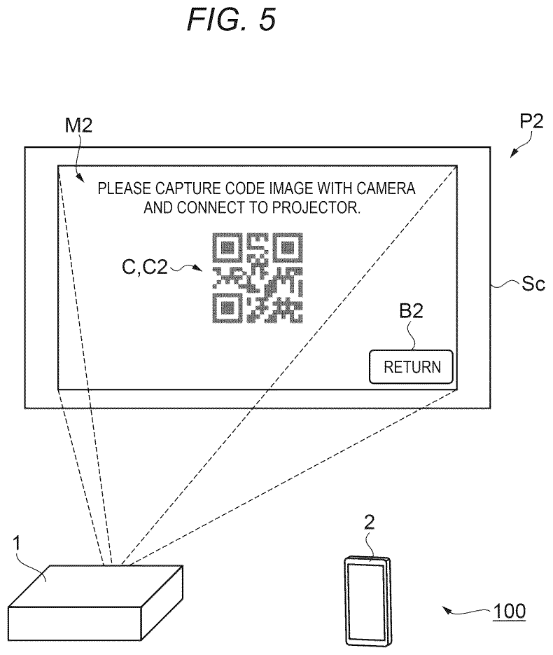

Image data of a code image C2 (see FIG. 5) representing connection information for connecting the terminal device 2 to the projection system 1 according to the connection program is stored in the first storage 11 of the projection system 1. The connection information includes, for example, a service set identifier (SSID) for identifying the wireless LAN, a password, and an IP address of the projection system 1. When the user captures the code image C2 projected from the projection system 1 with the imager 25 of the terminal device 2 in a state in which the connection program is started, the projection system 1 and the terminal device 2 are communicably connected by the wireless LAN. With this connection, an image displayed on the display 24 of the terminal device 2 can be projected from the projection system 1. The code image C2 is an example of a first code image. The IP address included in the connection information represented by the code image C2 is an example of a first address.

Colors of the plurality of code images C stored in the first storage 11 as the image data are not the same and are different from one another. In the present embodiment, the code image C1 for installing the connection program is a blue image. The code image C2 for connecting the projection system 1 and the terminal device 2 by the wireless LAN is a red image. That is, the projection system 1 displays the code image C2 in red and displays the code image C1 in blue different from red. Red is an example of a first color and blue is an example of a second color.

Next, an operation of the display system 100 at the time when the projection system 1 and the terminal device 2 are connected by the wireless LAN is explained.

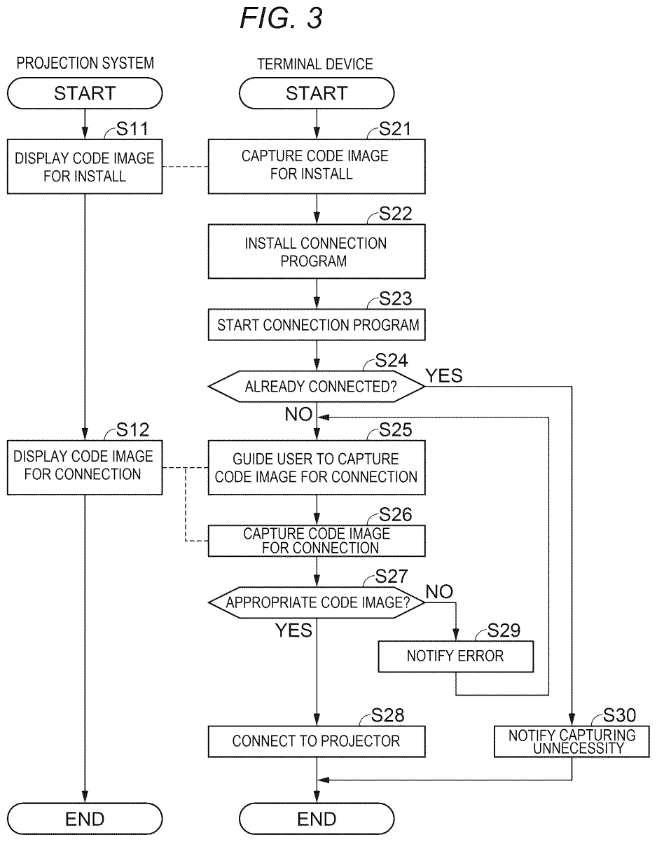

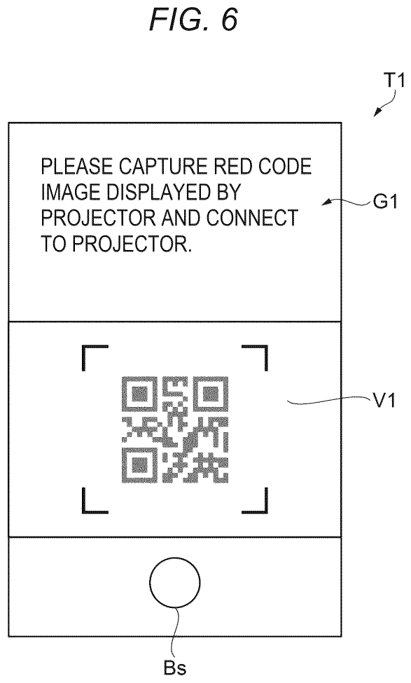

FIG. 3 is a flowchart illustrating the operation of the display system 100 at the time when the projection system 1 and the terminal device 2 are connected by the wireless LAN and includes the operation of the projection system 1 and the operation of the terminal device 2. FIGS. 4 to 8 are diagrams illustrating the operation of the display system 100. FIGS. 4 and 5 are diagrams illustrating projection images P1 and P2 projected by the projection system 1 and FIGS. 6 to 8 are diagrams illustrating display images T1, T2, and T3 displayed on the display 24 of the terminal device 2. When the user operates the first operation unit 13 of the projection system 1 to perform operation for connecting the projection system 1 and the terminal device 2 by the wireless LAN, the first controller 10 of the projection system 1 operates according to the flow illustrated in FIG. 3. It is assumed that the connection program explained above is not installed in the terminal device 2.

First, in step S11, the first controller 10 reads, from the first storage 11, image data of the code image C1 for installing the connection program. The first controller 10 then projects the projection image P1 including the code image C1 from the projector 14. Accordingly, as illustrated in FIG. 4, the blue code image C1 is displayed on the projection surface Sc. The first controller 10 displays, together with the code image C1, in the projection image P1, a message M1 for urging the user to capture the code image C1 and a forward button B1 to be operated when advancing to the next procedure.

When the code image C1 is displayed, the user operates the second operation unit 23 of the terminal device 2 to start the reading program. Then, the user holds the terminal device 2 to cause the imaging lens of the imager 25 to face the code image C1 on the projection surface Sc and performs, with the second operation unit 23, an operation for executing imaging.

In step S21, according to operation of the user, the second controller 20 of the terminal device 2 causes the imager 25 to capture the code image C1. In step S22, the second controller 20 accesses the URL represented by the code image C1 and installs the connection program in the terminal device 2. When the installation of the connection program is completed, in step S23, the second controller 20 starts the installed connection program. Thereafter, the second controller 20 operates according to the started connection program.

On the other hand, after finishing capturing the code image C1, the user operates the forward button B1 on the first operation unit 13 of the projection system 1 to thereby switch the projection image P1 of the projection system 1 to the next projection image P2 (see FIG. 5).

In step S12, in response to the operation of the forward button B1 by the user, the first controller 10 of the projection system 1 reads, from the first storage 11, image data of the code image C2 for connecting the projection system 1 and the terminal device 2 by the wireless LAN. The first controller 10 then projects the projection image P2 including the code image C2 from the projector 14. Accordingly, as illustrated in FIG. 5, the red code image C2 is displayed on the projection surface Sc. The first controller 10 displays, together with the code image C2, in the projection image P2, a message M2 for urging the user to capture the code image C2 and a backward button B2 operated when returning to the previous procedure.

In step S24, the second controller 20 determines whether the projection system 1 and the terminal device 2 have already been connected using another application program or the like. When the projection system 1 and the terminal device 2 are not connected yet (NO in step S24), the second controller 20 shifts the processing to step S25. On the other hand, when the projection system 1 and the terminal device 2 have already been connected (step S24: YES), the second controller 20 shifts the processing to step S30.

When the projection system 1 and the terminal device 2 are not connected yet and the processing shifts to step S25, the second controller 20 guides, with the display 24, the user to capture the code image C2. Specifically, the second controller 20 displays the display image T1 illustrated in FIG. 6 on the display 24. The display image T1 includes a monitor V1 for monitoring an imaging range of the imager 25, a shutter button Bs, and guidance information G1. The guidance information G1 is information for guiding the user to capture the code image C2 with the imager 25 and includes a message “Please capture a red code image displayed by the projector and connect to the projector”. That is, the guidance information G1 includes information indicating that a color of the code image C2 that should be captured is red. The guidance information G1 is an example of first guidance information. Here, for example, at least some characters in the guidance information G1 such as a “red code image” in the guidance information G1 are desirably written in red. In other words, it is desirable that at least some characters in the guidance information G1 have the same color as the color of the code image C2 that should be captured. The user holds the terminal device 2 to cause the imaging lens of the imager 25 to face the code image C2 on the projection surface Sc and operates the shutter button Bs with the second operation unit 23.

In step S26, the second controller 20 causes the imager 25 to capture the code image C2 according to the operation of the shutter button Bs.

In step S27, the second controller 20 determines whether an appropriate code image C2 has been captured. The second controller 20 can determine, based on a format or the like of information stored in the captured code image C, whether the appropriate code image C2 has been captured. When an appropriate code image C2 has been captured (step S27: YES), the second controller 20 shifts the processing to step S28. On the other hand, when an inappropriate code image C has been captured (step S27: NO), the second controller 20 shifts the processing to step S29. For example, when the user has forgotten to operate the forward button B1 of the projection image P1 or has erroneously operated the backward button B2 of the projection image P2, it can occur that an inappropriate code image C1 is captured.

When the appropriate code image C2 has been captured and the processing has shifted to step S28, the second controller 20 connects to the projection system 1 based on the connection information represented by the code image C2. That is, when the code image C2 has been captured by the imager 25, the second controller 20 accesses an IP address included in the connection information represented by the code image C2. As explained above, the projection system 1 and the terminal device 2 are connected by the wireless LAN. Thereafter, an image displayed on the display 24 of the terminal device 2 is projected from the projection system 1.

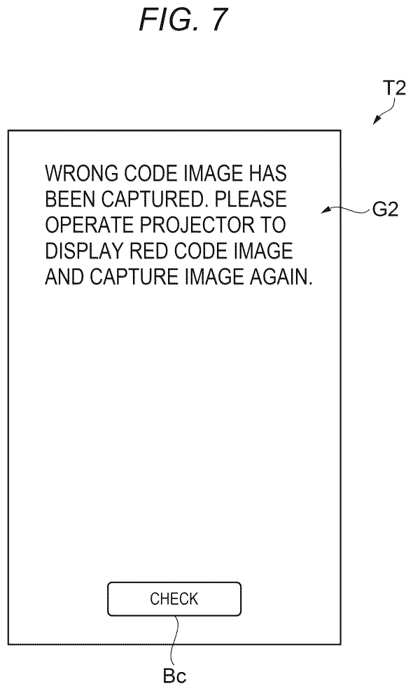

On the other hand, when the inappropriate code image C has been captured in step S27 and the processing has shifted to step S29, the second controller 20 notifies the user of the occurrence of an error. Specifically, the second controller 20 displays the display image T2 illustrated in FIG. 7 on the display 24. The display image T2 includes guidance information G2 for notifying that the captured code image C is inappropriate and guiding the user to operate the projection system 1 to display the red code image C2 and then perform imaging again and a confirmation button Bc. When the user checks the guidance information G2 and operates the confirmation button Bc, the second controller 20 does not access an address indicated by the captured inappropriate code image C, returns the processing to step S25, and guides the user to capture the code image C2 again. As explained above, when the code image C different from the code image C2 is captured by the imager 25, the second controller 20 does not access an address represented by the code image C captured by the imager 25. For example, when the code image C1 is captured by the imager 25, the second controller 20 does not access the URL represented by the code image C1.

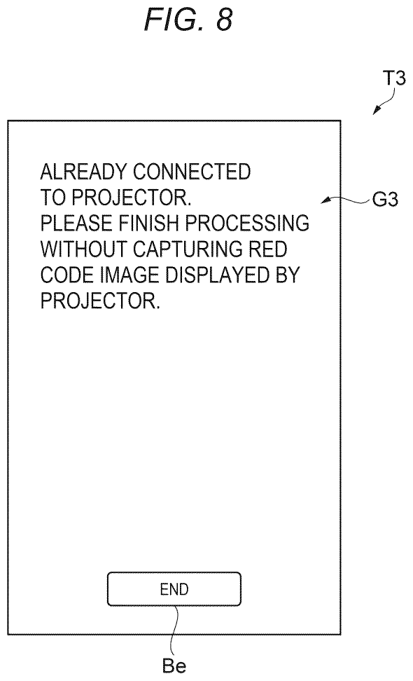

Further, in step S24, when the projection system 1 and the terminal device 2 have already been connected and the processing has shifted to step S30, the second controller 20 does not display the display image T1 and displays the display image T3 illustrated in FIG. 8 on the display 24. The display image T3 includes guidance information G3 for notifying that it is unnecessary to capture the code image C2 and an end button Be for ending the connection program. When the display image T3 is displayed, the user does not capture the code image C2 and ends the connection program by operating the end button Be on the second operation unit 23.

Step S24 of determining whether the projection system 1 and the terminal device 2 have been connected can be regarded as a step of determining whether to display the display image T1 including the guidance information G1 on the display 24. When it is determined not to display the guidance information G1 on the display 24 (step S24: YES), in step S30, the second controller 20 displays, on the display 24, guidance information G3 for notifying that it is unnecessary to capture the code image C2. The guidance information G3 is an example of second guidance information.

As explained above, according to the display system 100 in the present embodiment and the terminal device 2, the following effects can be obtained.

According to the present embodiment, the projection system 1 displays the plurality of code images C1 and C2 in different colors and the guidance information G1 for guiding the user to capture the code image C2 is displayed on the display 24 of the terminal device 2. The guidance information G1 clearly indicates a color of the code image C2 that should be captured. For this reason, the user can discriminate, with a color of the code image C, whether the code image C to be captured is the code image C2. As a result, the user is prevented from capturing the code image C different from the code image C2 that should be captured.

According to the present embodiment, when the code image C different from the code image C2 that should be captured has been captured, since an address represented by the captured code image C is not accessed, unnecessary access to the address can be prevented.

According to the present embodiment, in step S24, when the terminal device 2 has already been connected to the projection system 1, that is, when the second controller 20 determines not to display the guidance information G1 on the display 24, the guidance information G3 for notifying that it is unnecessary to capture the code image C2 is displayed on the display 24. Accordingly, the user can reduce a manhour required to capture the code image C2.

### 2. Modifications

Although the embodiment explained above is based on the configuration explained above, it is also possible to, for example, partially change or omit the configuration without departing from the gist of the present disclosure. The present embodiment and modifications explained below can be implemented in combination with each other within a technically consistent range. Hereinafter, the modifications are explained.

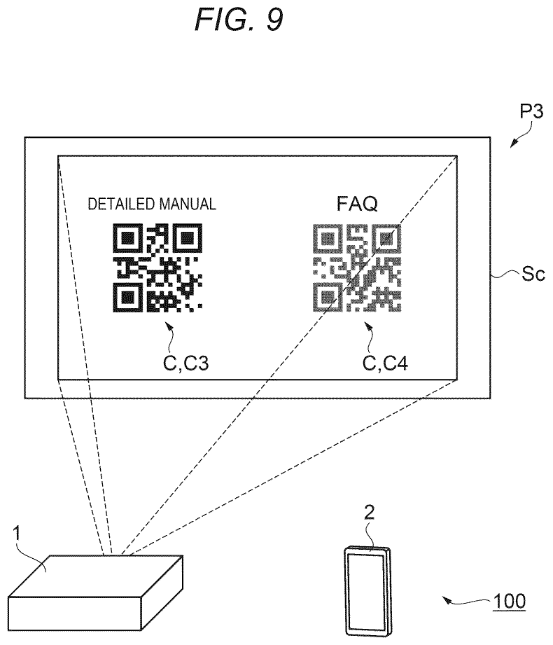

In the embodiment explained above, an aspect in which the plurality of code images C1 and C2 are displayed in predetermined order is explained. However, an aspect in which the plurality of code images C are simultaneously displayed may be adopted. In an example illustrated in FIG. 9, two code images C3 and C4 are arranged side by side in one projection image P3. One code image C3 is the code image C representing a URL for displaying a detailed manual of the projection system 1 and is displayed in black. The other code image C4 is the code image C representing a URL for displaying frequently asked questions (FAQs) concerning the projection system 1 and is displayed in green.

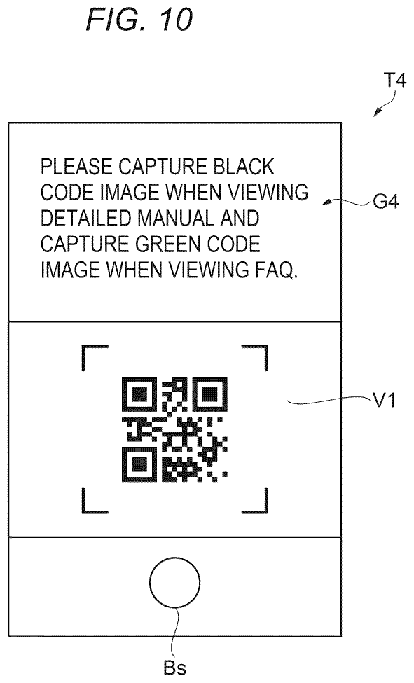

On the other hand, the second controller 20 of the terminal device 2 displays a display image T4 illustrated in FIG. 10 on the display 24. The display image T4 includes a monitor V1 for monitoring the imaging range of the imager 25, a shutter button Bs, and guidance information G4. The guidance information G4 is information for guiding the user to capture the code images C3 and C4 with the imager 25 and includes a message “Please capture a black code image when viewing the detailed manual and capture a green code image when viewing the FAQ”. That is, the guidance information G4 includes information indicating that a color of the code image C3 is black and information indicating that a color of the code image C4 is green. Therefore, by referring to the colors of the two code images C3 and C4, the user can appropriately capture one code image C that should be captured.

In the embodiment explained above, the code image C is not limited to the QR code. For example, the code image C may be a two-dimensional code other than the QR code or may be a one-dimensional barcode. The code image C may be a code image, a pattern of which changes with time.

In the embodiment explained above, it is desirable to clearly indicate the color of the code image C that should be captured in an instruction manual distributed to the user with a paper medium or an electronic medium. For example, in the instruction manual, in an explanatory text for explaining the capturing of the code image C1 in step S21, “Please capture a blue code image displayed by the projector and install the connection program” is written. In an explanatory text for explaining the imaging of the code image C2 in step S26, as in the guidance information G1, “Please capture a red code image displayed by the projector and connect to the projector” is written. In the instruction manual as well, it is desirable that at least some of characters in the explanatory texts have the same color as the color of the code image C that should be captured.

In the embodiment explained above, an aspect in which the projection system 1 and the terminal device 2 are communicably connected is explained. However, it is sufficient that the terminal device 2 captures the code image C displayed by the projection system 1 and is not limited to an aspect in which the projection system 1 and the terminal device 2 are connected.

In the embodiment explained above, the code image C represents an address such as a URL or an IP address. However, the code image C may represent information other than the address.

In the embodiment explained above, the projection system 1 is explained as an example of the image display device. However, the image display device is not limited to the projection system 1 and may be another image display device such as a liquid crystal display or an organic EL display.

### 3. Summary of the Present Disclosure

A summary of the present disclosure is appended below.

(Appendix 1) A display system including: an image display device; and an information processing device including a camera, a display, and a controller, wherein the image display device displays a first code image in a first color and displays a second code image in a second color different from the first color, the controller displays, on the display, first guidance information for guiding a user to capture the first code image with the camera, and the first guidance information includes information indicating that a color of the first code image is the first color.

According to the configuration of Appendix 1, the image display device displays a plurality of code images in different colors, and the first guidance information for guiding the user to capture a code image is displayed on the display of the information processing device. The first guidance information clearly indicates a color of a code image that should be captured. For this reason, the user can discriminate, with a color of a code image to be captured, whether the code image is the code image that should be captured. As a result, the user is prevented from capturing a code image different from the code image that should be captured.

(Appendix 2) The display system described in Appendix 1, wherein the controller accesses a first address represented by the first code image when the first code image is captured by the camera and does not access a second address represented by the second code image when the second code image is captured by the camera.

According to the configuration of Appendix 2, when a code image different from the code image that should be captured is captured, since an address represented by the captured code image is not accessed, it is possible to prevent unnecessary access to the address.

(Appendix 3) The display system described in Appendix 1 or 2, wherein the controller determines whether to display the first guidance information on the display and, when determining not to display the first guidance information on the display, displays, on the display, second guidance information for notifying that it is unnecessary to capture the first code image.

According to the configuration of Appendix 3, when the controller determines not to display the first guidance information on the display, the second guidance information for notifying that it is unnecessary to capture the first code image is displayed on the display. Accordingly, the user can reduce a manhour required to capture the first code image.

(Appendix 4) An information processing device including a camera, a display, and a controller, wherein the controller displays, on the display, first guidance information for guiding a user to capture, among a first code image displayed in a first color by an image display device and a second code image displayed in a second color different from the first color by the image display device, the first code image with the camera, and the first guidance information includes information indicating that a color of the first code image is the first color.

According to the configuration of Appendix 4, the first guidance information for guiding the user to capture a code image is displayed on the display of the information processing device, and a color of a code image that should be captured is clearly indicated in the first guidance information. For this reason, the user can discriminate, with a color of a code image to be captured, whether the code image is the code image that should be captured. As a result, the user is prevented from capturing a code image different from the code image that should be captured.

What is claimed is:

1. A display system comprising:
an image display device; and
an information processing device including a camera, a display, and a controller, wherein
the image display device displays a first code image in a first color and displays a second code image in a second color different from the first color,
the controller displays, on the display, first guidance information for guiding a user to capture the first code image with the camera, and
the first guidance information includes information indicating that a color of the first code image is the first color.

2. The display system according to claim 1, wherein the controller accesses a first address represented by the first code image when the first code image is captured by the camera and does not access a second address represented by the second code image when the second code image is captured by the camera.

3. The display system according to claim 1, wherein the controller determines whether to display the first guidance information on the display and, when determining not to display the first guidance information on the display, displays, on the display, second guidance information for notifying that it is unnecessary to capture the first code image.

4. An information processing device comprising: a camera; a display; and a controller, wherein
the controller displays, on the display, first guidance information for guiding a user to capture, among a first code image displayed in a first color by an image display device and a second code image displayed in a second color different from the first color by the image display device, the first code image with the camera, and
the first guidance information includes information indicating that a color of the first code image is the first color.
